(19) United States
(12) Patent Application Publication
(10) Pub. No.: US 2004/0088594 A1
(43) Pub. Date: May 6, 2004

(54) Receiver tracking mechanism for an I/O circuit

(76) Inventors: Karthisha S. Canagasaby, Santa Clara, CA (US); Sanjay Dabral, Palo Alto, CA (US); Chamath Abhayagunawardhana, Portland, CA (US); Ken Drottar, Portland, CA (US); David S. Dunning, Portland, CA (US)

Correspondence Address: ANTONELLI, TERRY, STOUT & KRAUS, LLP, 1300 NORTH SEVENTEENTH STREET, SUITE 1800, ARLINGTON, VA, 22209-9889, US

(21) Appl. No.: 10/284,245

(22) Filed: Oct. 31, 2002

(51) Int. Cl. G06F 1/12

(52) U.S. Cl. 713/400

(57) ABSTRACT

A receiver circuit is provided with a front amplifier to receive data from an I/O link driven by a remote clock signal; an interpolator to generate a local clock signal to track the remote clock signal encoded in the data; and a tracking mechanism to extract phase information about the remote clock signal from the data and to dynamically adjust the phase of the local clock signal that tracks the remote clock signal in accordance with extracted phase information for subsequent data processing functions, wherein the tracking mechanism is configured to predict the direction of a phase drift, and force the interpolator to move against the phase drift so as to reduce lock time.

### FIELD

The present invention relates generally to integrated circuits (ICs) and, more specifically, relates to a tracking-based receiver system utilizing a mechanism to track data with faster locking time, more robust phase tracking and finer interpolator resolution that aids applications such as input/output (I/O) testing with greater timing margins.

### BACKGROUND

Integrated circuits (ICs) typically contain one or more functional logic blocks, such as a micro-processor, micro-controller, graphics controller, bus interface circuit, input/output (I/O) circuit, memory circuit, and the like. ICs are typically assembled into packages, known as “IC chips” that are physically and electrically coupled to a substrate such as a printed circuit board (PCB) or a ceramic substrate to form an “electronic assembly”. The “electronic assembly” can be part of an “electronic system”. An “electronic system” is broadly defined herein as any product comprising an “electronic assembly”. Examples of electronic systems include computers (e.g., desktop, laptop, hand-held, server, etc.), wireless communications devices (e.g., cellular phones, cordless phones, pagers, etc.), computer-related peripherals (e.g., printers, scanners, monitors, etc.), entertainment devices (e.g., televisions, radios, stereos, tape and compact disc players, video cassette recorders, MP3 (Motion Picture Experts Group, Audio Layer 3) players, etc.), and the like.

In these electronic systems, especially computers and communication devices, IC chips must generally be tested before they are incorporated into an electronic assembly in order to verify that each component of each functional logic block on the IC chip functions properly and to verify that I/O circuits of each IC chip operate correctly within specified timing parameters or timing margins. In addition, clock signals whose phase and frequency must be also tracked properly for I/O testing purposes.

Receiver tracking mechanisms including phase tracking interpolators are known to provide dynamic tracking of a clock signal at the receiver front end of an I/O link in an IC chip. However, typical interpolators do not mix phases of a clock signal linearly as desired, and require a substantially long lock time for phase tracking of a clock signal.

For reasons stated above, and for other reasons stated below which will become apparent to those skilled in the art upon reading and understanding the present specification, there is a significant need for a receiver tracking mechanism including a phase tracking interpolator that can be used at a receiver front end of an I/O link in an IC chip to obtain faster locking time, phase tracking and finer interpolation required for applications such as I/O testing with greater timing margins.

### BRIEF DESCRIPTION OF THE DRAWING(S)

A better understanding of the present invention will become apparent from the following detailed description of example embodiments and the claims when read in connection with the accompanying drawings, all forming a part of the disclosure of this invention. While the following written and illustrated disclosure focuses on disclosing example embodiments of the invention, it should be clearly understood that the same is by way of illustration and example only and that the invention is not limited thereto. The spirit and scope of the present invention are limited only by the terms of the appended claims. The following represents brief descriptions of the drawings, wherein:

FIGS. 1A-1B illustrate an example system including a plurality of IC components (IC chips) connected via one or more I/O links;

FIG. 2 illustrates an example I/O circuit including a driver circuit and a receiver circuit at a front end of an IC chip;

FIG. 3 illustrates an example receiver circuit in an IC chip including a receiver tracking mechanism with a phase tracking interpolator according to an embodiment of the present invention;

FIG. 4 illustrates an example tracking “recovered” clock and an example sampling clock used to track data received in the example receiver circuit shown in FIG. 3;

FIGS. 5A-5B illustrate a timing diagram of an example locking action by the example phase tracking interpolator shown in FIG. 3;

FIG. 6 illustrates a Gaussian representation of an example locking action by the example phase tracking interpolator shown in FIG. 3;

FIGS. 7A-7B illustrate an abstract operation representation of the example phase tracking interpolator shown in FIG. 3;

FIG. 8 illustrates an example diagram of an “against the drift” forcing action by an example phase tracking interpolator shown in FIG. 3;

FIG. 9 illustrates an example receiver tracking mechanism including a drift direction predictor according to an embodiment of the present invention;

FIG. 10 illustrates an example detailed implementation of the example receiver tracking mechanism including a drift direction predictor shown in FIG. 9;

FIG. 11 illustrates a flowchart of an example drift direction measurement performed by the receiver tracking mechanism according to an embodiment of the present invention;

FIGS. 12A-12F illustrate timing diagrams of an example clock pattern during the drift direction measurement shown in FIG. 11;

FIGS. 13A-13E illustrate example steps involved in reducing non-linearity in phase tracking interpolation according to an embodiment of the present invention;

FIG. 14 illustrates an example phase tracking interpolator according to an embodiment of the present invention;

FIG. 15 illustrates an example phase tracking interpolator according to another embodiment of the present invention;

FIG. 16 illustrates an example comparison of linearity between weighted and uniform current sources with no capacitive loads;

FIG. 17 illustrates an example comparison of linearity between weighted and uniform current sources with capacitive loads;

FIGS. 18A-18D illustrate example edge and data sampling clocks from the example phase tracking interpolator shown in FIG. 3;

FIG. 19 illustrates an example synchronization and alignment unit (SAU) designed to improve meta-stability according to an embodiment of the present invention;

FIG. 20 illustrates an example alignment unit of the example synchronization and alignment unit (SAU) according to an embodiment of the present invention;

FIG. 21 illustrates an example timing diagram of obtaining extra settling time by pipelining edge samples before data sample according to an embodiment of the present invention;

FIG. 22 illustrates an example vote generator in the example receiver tracking mechanism according to an embodiment of the present invention;

FIG. 23 illustrates an example vote generator implementation as a look-up table in the example receiver tracking mechanism according to another embodiment of the present invention;

FIG. 24 illustrates an example loop filter in the example receiver tracking mechanism according to an embodiment of the present invention; and

FIG. 25 illustrates an example interpolator control unit in the example receiver tracking mechanism according to an embodiment of the present invention.

### DETAILED DESCRIPTION

Before beginning a detailed description of the subject invention, mention of the following is in order. When appropriate, like reference numerals and characters may be used to designate identical, corresponding or similar components in differing figure drawings. Further, in the detailed description to follow, example sizes/values/ranges may be given, although the present invention is not limited to the same. As manufacturing techniques mature over time, it is expected that CMOS devices and IC chips of smaller size can be manufactured. In addition, well known logic interfaces and connections to IC chips and other components may not be shown within the figures for simplicity of illustration and discussion, and so as not to obscure the invention. Further, arrangements may be shown in block diagram form in order to avoid obscuring the invention, and also in view of the fact that specifics with respect to implementation of such block diagram arrangements are highly dependent upon the platform within which the present invention is to be implemented, i.e., such specifics should be well within purview of one skilled in the art. Where specific details (e.g., circuits) are set forth in order to describe example embodiments of the invention, it should be apparent to one skilled in the art that the invention can be practiced without, or with variation of, these specific details.

The present invention is applicable for use with all types of electronic systems and integrated circuit (IC) chips, including, for example, micro-processors, microcontrollers, graphics controllers, bus interface circuits, input/output (I/O) circuits, memory circuits, and any other IC chips which may become available as semiconductor technology develops in the future. Examples of electronic systems may include computers (e.g., desktop, laptop, hand-held, server, etc.), wireless communications devices (e.g., cellular phones, cordless phones, pagers, etc.), computer-related peripherals (e.g., printers, scanners, monitors, etc.), entertainment devices (e.g., televisions, radios, stereos, tape and compact disc players, video cassette recorders, MP3 (Motion Picture Experts Group, Audio Layer 3) players, etc.), and the like.

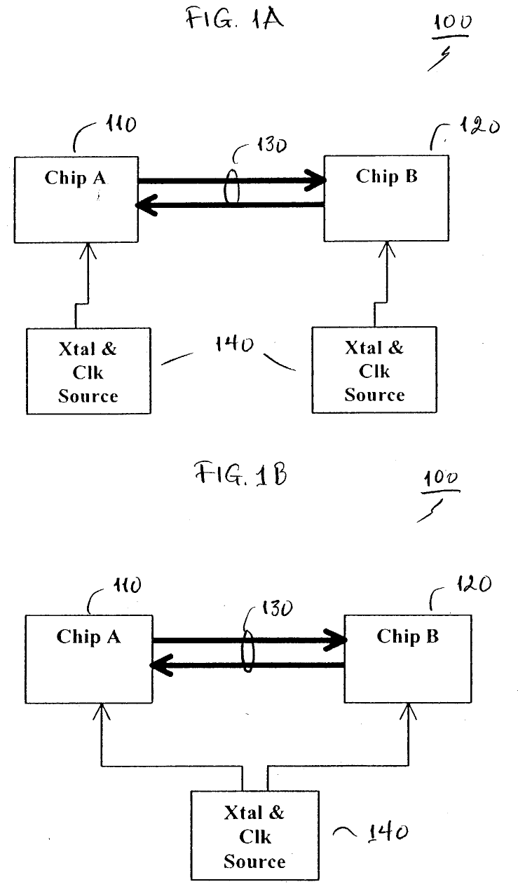

Attention now is directed to the drawings and particularly to FIGS. 1A-1B, in which an example electronic system 100 including a plurality of IC components 110-120 connected via one or more I/O links 130 according to embodiments of the present invention is illustrated. The electronic system 100 may be a data processing system that comprises a plurality of IC components, such as processor, a graphics processor, chipset logic, and external memory. These components may be mounted on a single printed circuit board (PCB) or multiple PCBs within the electronic system 100, and may be connected, via one or more high speed I/O links. The “processor” may be any type of computational circuit, such as but not limited to a micro-processor, a micro-controller, a complex instruction set computing (CISC) microprocessor, a reduced instruction set computing (RISC) microprocessor, a very long instruction word (VLIW) microprocessor, a graphics processor, a digital signal processor (DSP), or any other type of processor or processing circuit. Chipset logic can be any one or more supporting circuits that couple processor to external devices. For example, chipset logic can include input/output (I/O) circuits, bus circuits, debug circuits, node control circuits, port switching circuits, memory controller circuits, and so forth. External memory can include main memory in the form of random access memory (RAM), one or more hard drives(s), and removable media such as diskettes, compact disks (CD's), digital video disks (DVD's), and the like.

As shown in FIGS. 1A-1B, the electronic system 100 may require one or more clock sources utilized to generate clock signals. For example, each IC chip 110 or 120 in the electronic system 100 may have its own clock source 140 as shown in FIG. 1A, or alternatively, may share a common clock source 140 as shown in FIG. 1B. The system 100 having two clock sources that have reference clock frequencies within a specified tolerance, shown in FIG. 1A, may be known as “plesiochronous” system. The system 100 having a single clock source that have the same reference clock frequency, shown in FIG. 1B, may be known as “mesochronous” system. Examples of such a clock source may include a quart crystal, a phase-locked loop (PLL) circuit and a delay-locked loop (DLL) circuit utilized to generate a reference clock signal or a clock signal that has the same frequency as that of a reference clock signal or an integer multiple of the reference frequency but whose phase may deviate from that of the reference clock by an amount that is within a pre-defined range.

The electronic system 100 shown in FIGS. 1A-1B is merely one example of an electronic system in which the present invention can be used. Other types of electronic systems with which the present invention can be used include communications equipment, such as Internet computers, cellular telephones, pagers, and two-way radios; entertainment systems; process control systems; aerospace equipment; automotive equipment; and similar electronic systems.

FIG. 2 illustrates an example I/O circuit 200 within each IC chip 110 or 120 that is arranged at a front end of an I/O link 140 shown in FIGS. 1A-1B. Each I/O circuit 200 generally contains a driver circuit (i.e., transmitter) 210 and a receiver circuit 220. When the I/O circuit 200 is outputting data, the receiver circuit 220 may be disabled and the driver circuit 210 may be enabled to drive data, via an I/O link 140. When the I/O circuit 200 is receiving data, the driver circuit 210 may be disabled and the receiver circuit 220 may be enabled to receive data from the I/O link 140.

During serial communication between IC chip 110 and IC chip 120, for example, the driver circuit (transmitter) 210 of IC chip 110 encodes its clock into the data stream. In order to extract the data sent from the driver circuit (transmitter) 210 of IC chip 110, via the I/O link 130, the receiver circuit 220 of IC chip 120 must recreate and track the remote data clock (also known as “received clock”) for subsequent data processing functions.

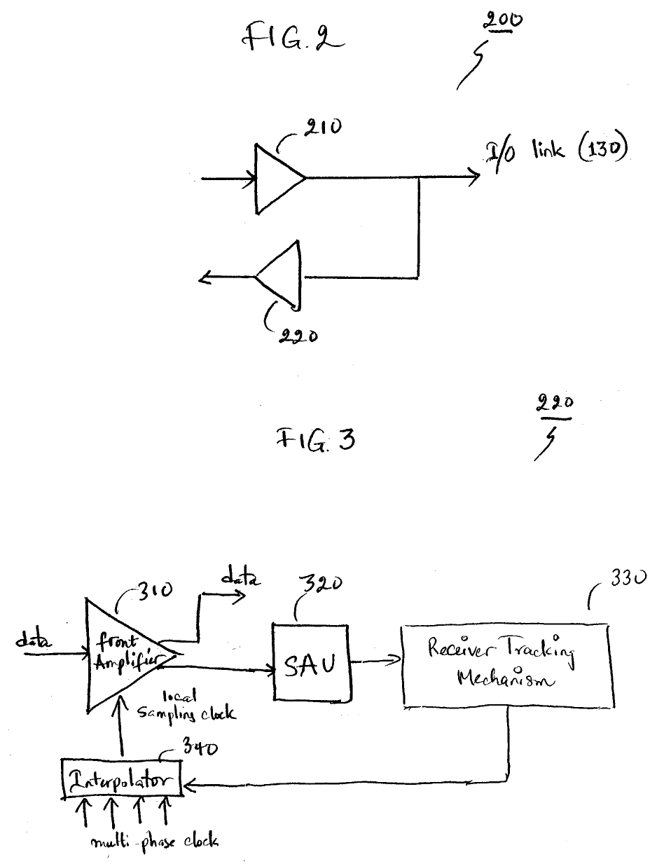

Each receiver circuit 220 may comprise, as shown in FIG. 3, a plurality of circuit elements, such as a front amplifier 310 arranged to receive and amplify data from an I/O link 130; a synchronization and alignment unit (SAU) 320 arranged to align and synchronize data and edge samples to single recovered clock edge; a receiver tracking mechanism 330 arranged to perform the dynamic tracking function of data and edge samples; and a phase tracking interpolator 340 arranged to perform the interpolation function of data and edge samples so as to obtain fast locking time and finer interpolation.

In general, the receiver tracking mechanism 330 may be implemented as a state machine used to extract the phase/frequency information about the remote data clock (“received clock”) from the data stream received from the I/O link 130, and dynamically adjust the phase/frequency of a local sampling clock generated by the interpolator 340 that tracks the remote data clock (received clock) based on the extracted phase/frequency information from the data stream received from the I/O link 130. An example sampling clock 410 and an example tracking “recovered” clock 420 used by the receiver circuit 220 to track data received from the I/O link 130 are shown in FIG. 4. Based on the number of tracking indications and filtering, the tracking and sampling clocks 410 and 420 track the data received from the I/O link 130.

In normal initial locking situation depending on where the data and receive clock are at startup, the phase tracking interpolator 340 may attempt to lock to the nearest edge of the data stream as shown in FIG. 4. However, if the phase drift (measured between incoming data phase and remote data clock which can be positive or negative) and the interpolator movement are in the same direction, the relative velocity is slow, therefore a longer lock time results.

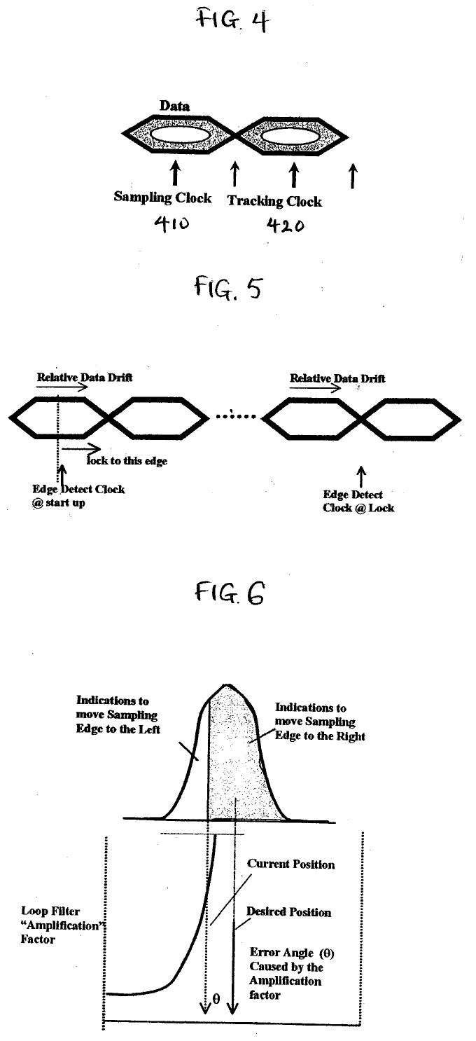

FIGS. 5A-5B show a timing diagram of an example locking action by the phase tracking interpolator 340. As shown in FIG. 5A, if the relative phase drift is from left to right, and the interpolator movement is in the same direction, the phase tracking interpolator 340 will lock to the next edge sample as shown in FIG. 5B. f the relative velocity of the phase tracking interpolator 340 is slow, then a longer lock time results. Longest lock time may occur when the edge detection clock is near the center of a data sample, and the phase drift and the interpolator movement are in the same direction as shown in FIG. 5A.

The lock time may be determined by several factors, including the interpolator velocity, the phase drift and the phase angle needed to be traversed to lock. In addition, the lock time can also be increased because of the relative filter amplification of internal loop filter of the receiver tracking mechanism 330 as shown in FIG. 3. This is caused when the phase tracking interpolator 340 approaches the jittering edge of the data stream that it is trying to lock onto. Near this position the indications cancel each other, therefore a significantly increased number of indications are required to move the phase tracking interpolator 340. The Filter Amplification can be expressed as:

$${FilterAmp}_{Interpolator} = \frac{1}{erfc ( \frac{τ}{σ} )}$$

where sigma (σ) represents a standard deviation, and (τ) represents a position from the mean of a Gaussian distribution, as shown in FIG. 6.

If there are N interpolator legs (each representing [360/N]°), the number of maximum indications per unit time is “I” and the internal loop filter is set at “F”, then the maximum rate of change (phase drift) for the phase tracking interpolator 340 may be expressed as follows:

$$\frac{ⅆ φ}{ⅆ {t}_{Interpolator}} = \frac{{360}^{°}}{N} \times \frac{I}{F}$$

One of the worst culprits for high rates of phase change is the clock difference in the two communicating components, for example, IC chips 110 and 120 in the plesiochronous system shown in FIG. 1A. For a 300 ppm crystal tolerance, a rate of change of phase drift may be determined as 300×10⁻⁶ (ppm)×1.25×10⁹ (freq)=375×10³ Hz or 375 KHz.

FIG. 6 illustrates an example Gaussian distribution of an example locking action by the phase tracking interpolator 340. As shown in FIG. 6, the phase tracking interpolator 340 (at startup) is trying to catch up to a desired lock edge, i.e., desired position, moving in the same direction as the interpolator 340. The further the phase tracking interpolator 340 is away from the desired position, the faster the phase tracking interpolator 340 will move towards locking. However, as the interpolator 340 moves closer to locking, its relative velocity will be slower, the loop filter amplification will be much higher and, as a result, the lock time may be large and can be expressed as follows.

$$\frac{ⅆ φ}{ⅆ {t}_{Interpolator}} \geq \frac{ⅆ φ}{ⅆ {t}_{link}}$$

If the interpolator velocity is equal to the drift velocity, lock will never be achieved. As a result, the interpolator velocity needs to be increased to ensure the desired lock time specification. However, any interpolator velocity increase may result in coarser interpolator granularity or lower filter setting that may lead to less noise filtering. Therefore, in order to improve the locking action of the phase tracking interpolator 340 shown in FIG. 3, drift direction control logic may be incorporated into the receiver tracking mechanism 330 to force the interpolator 340 to go “against the drift”, resulting in faster lock times.

FIGS. 7A-7B illustrate an abstract representation of the phase tracking interpolator 340 trying to catch up the phase drift when the phase drift and the interpolator velocity are in the same direction leading to longer lock times, and when the interpolator velocity is in an opposite direction of the phase drift leading to shorter lock times. As previously discussed, if the interpolator velocity and the phase drift are in the same direction, then the phase tracking interpolator 340 needs to catch up as shown in FIG. 7A; otherwise, lock may never be achieved. However, if the interpolator velocity is in an opposite direction of the phase drift as shown in FIG. 7B, the lock time can be significantly reduced. Both the interpolator stepping rate and stepping size need to be set in accordance with the phase change allowed in the I/O link and the number of tracking edges guaranteed.

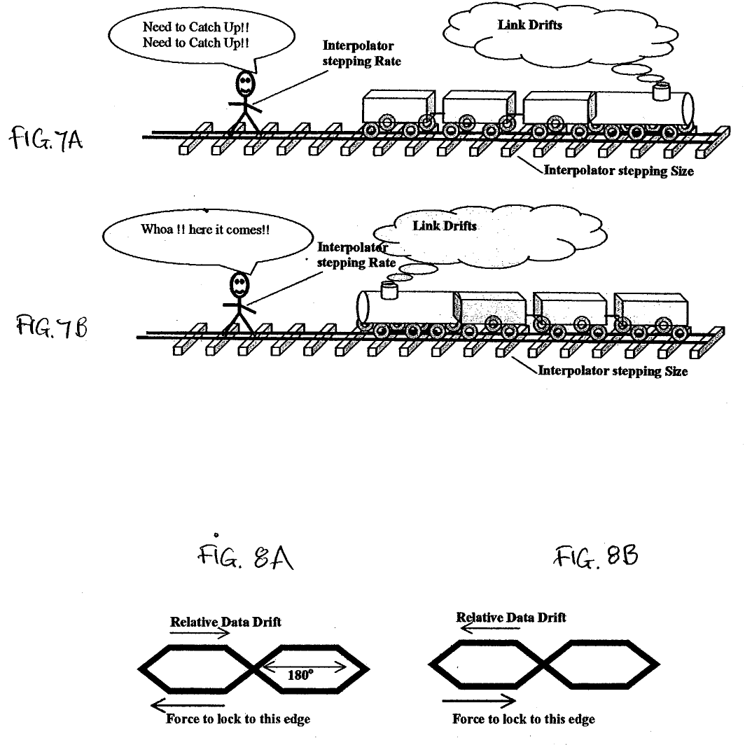

FIGS. 8A-8B illustrate an example timing diagram of an “against the drift” forcing action by the phase tracking interpolator 340. If the relative phase drift is moving from left to right, then the phase tracking interpolator 340 is forced to lock to the left edge of a data sample as shown in FIG. 8A. Likewise, if the relative phase drift is moving from right to left, then the phase tracking interpolator 340 is forced to lock to the right edge of a data sample as shown in FIG. 8B.

Turning now to FIG. 9, an example implementation of the receiver tracking mechanism 330 designed to force the phase tracking interpolator 340 to go “against the drift” in order to advantageously reduce lock time according to an embodiment of the present invention is illustrated. The “go against the drift” based approach may be best applicable for plesiochronous systems based on recovered clocks as described with reference to FIG. 1A.

As shown in FIG. 9, the receiver tracking mechanism 330 may comprise a vote generator 332 arranged to vote whether to move up/down the local sampling clock φₛ based on the accumulation and analysis of both data and edge samples; a loop filter 334 arranged to provide appropriate filter amplification of the up/down votes from the vote generator 332; a drift direction predictor 336 arranged to measure the drift direction; and an interpolator control unit 336 arranged to control operation of the phase tracking interpolator 338, including drift compensation, based on the up/down controls from the loop filter 334. For example, an up vote from the vote generator 332 may require the interpolator control unit 336 to delay the phases of a local sampling clock φₛ until a lock condition is established. Likewise, a down vote from the vote generator 332 may require the interpolator control unit 336 to advance the phases of a local sampling clock φₛ until a lock condition is established.

The drift direction predictor 336 may contain discrete logic components, such as a direction predictor 336A arranged to predict the direction of the phase drift, and a drift predictor 336B arranged to predict the drift compensation necessary to ensure the interpolation movement “against the drift.”

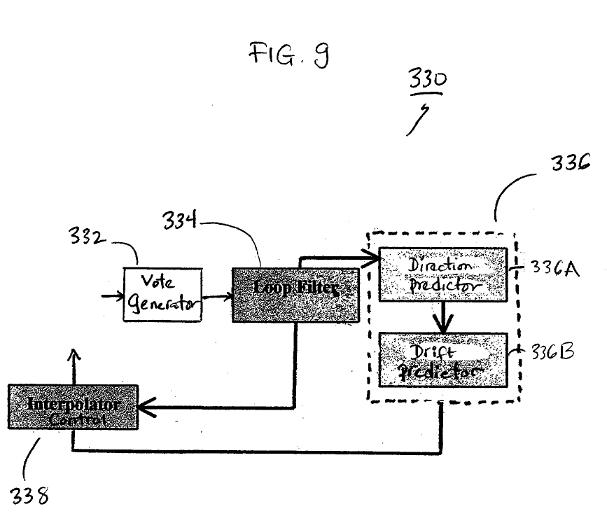

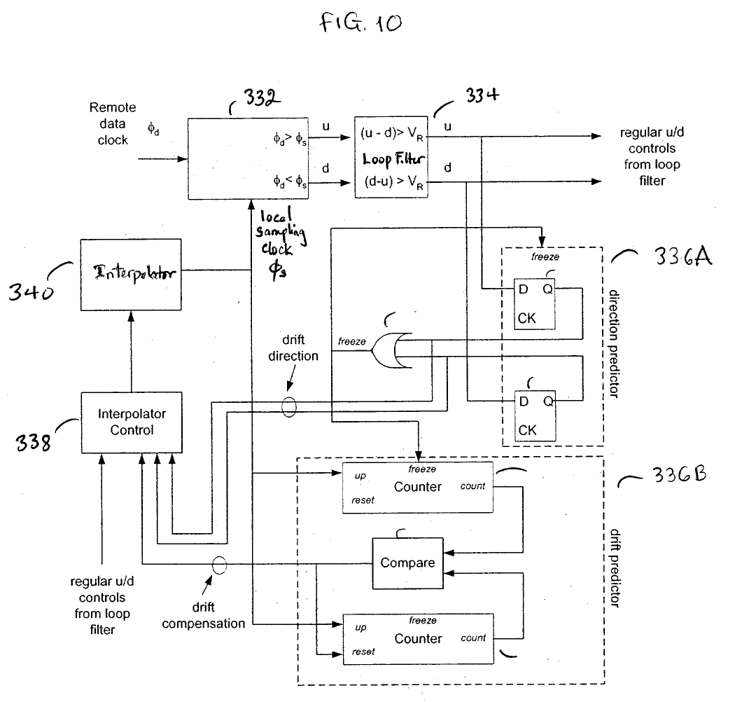

FIG. 10 illustrates an example detailed implementation the receiver tracking mechanism 330 including a drift direction predictor 336 according to an embodiment of the present invention. As shown in FIG. 10, the vote generator 332 may be replaced with a phase comparison circuit to receive a remote data clock φ_{d} from the I/O link 130 and make a comparison with a local sampling clock φₛ in order to determine whether the remote data clock φ_{d} is greater or smaller than the local sampling clock φₛ. The loop filter 334 may be used to provide appropriate filter amplification to the up/down controls from the phase comparison circuit 332. The drift direction predictor 336 includes a direction predictor 336A to determine the phase drift direction, and a drift predictor 336 to compensate for the phase drift. The interpolator control unit 338 may then control the operation of the phase tracking interpolator 340 based on the up/down controls from the loop filter 334, the drift direction predicted from the direction predictor 336A and the drift compensation provided from the drift predictor 336B.

The direction predictor 336A may include delay (D) flip-flops 512 and 514 arranged to receive regular up/down controls from the loop filter 33 and produce logic outputs that indicate the drift direction. The logic outputs from the D flip-flops 512 and 514 may be logically combined by an OR gate 530 and fed back to control the D flip-flops 512 and 514. Each D flip-flop 512 or 514 has a single data input (D) and a single data output (Q) delayed by one clock pulse.

The drift predictor 336B may include counters 522 and 524 arranged to count the remote data clock (received clock) φ_{d} and the local sampling clock (receiver clock) φₛ; and a comparator 526 arranged to compare clock counts from the counters 522 and 524 to determine the drift direction and provide the drift compensation to ensure that the interpolator movement is “against the drift”. The difference in clock count indicates the drift direction, and also indicates the edge of a data sample the phase tracking interpolator 340 needs to lock onto.

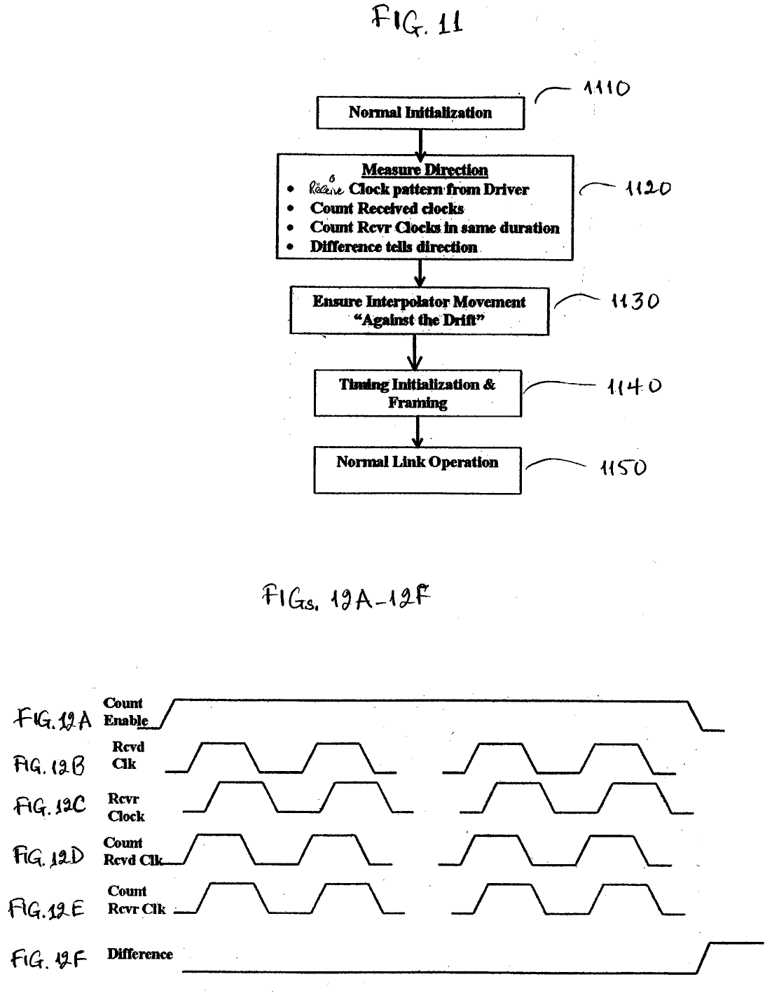

FIG. 11 illustrates a flowchart of an example drift direction measurement performed by the receiver tracking mechanism 330 according to an embodiment of the present invention. Timing diagrams of an example clock pattern during the drift direction measurement are shown in FIGS. 12A-12E.

The receiver tracking mechanism 330 starts its normal initialization at block 1110, and begins to measure the drift direction at block 1120. Specifically, the receiver tracking mechanism 330 may be activated by count enable shown in FIG. 12A to receive clock patterns including a remote data clock (received clock) from the incoming data received via the I/O link 130, as shown in FIG. 12B, and a local sampling clock (receiver clock) 100ₛ, as shown in FIG. 12C; to count the remote data clock (received clock) φ_{d}, as shown in FIG. 12D; to count the local sampling clock (receiver clock) φₛ in the same duration, as shown in FIG. 12E; and to determine if the difference in clock count indicates the drift direction, shown in FIG. 12FE. Both the received clock, as shown in FIG. 12B, and the receiver clock, as shown in FIG. 12C, are counted in the same duration until there is a mismatch. If the received clock count, as shown in FIG. 12C, is greater than the receiver clock count, as shown in FIG. 12D, then the phase drift may be considered as drifting toward the interpolator 340. However, if the received clock count, as shown in FIG. 12C, is less than the receiver clock count, as shown in FIG. 12D, the phase drift may be considered as drifting away or “against” the interpolator 340.

If the drift direction is determined as drifting away or “against” the interpolator 340, the receiver tracking mechanism 330 may be configured to ensure that the interpolator movement “against the drift” at block 1130, and establish timing initialization and framing at block 1140 and normal link operation at block 1150. However, if the drift direction is determined as drifting towards the interpolator 340, the receiver tracking mechanism 330 may bypass block 1130 and establish timing initialization and framing at block 1140 and normal link operation at block 1150.

Referring back to FIG. 3, the example phase tracking interpolator 340 used to adjust the phase of a local sampling clock (receiver clock) φₛ to match the phase of a remote data clock (received clock) φ_{d} may be especially optimized to improve linearity and reduce sampling jitter and glitch noise in the timing budget of the I/O link 130. According to an embodiment of the invention present invention, a weighted current leg method may be utilized to equalize, apportion and distribute current among phases of a local sampling clock (receiver clock) φₛ that are being interpolated while maintaining the total current drawn in order to reduce non-linearity in phase mixing. The weight may be made adaptive depending on the circuit behavior in silicon to optimize a linear phase interpolation transfer function over an extended range of process, voltage, and temperature that better dynamic tracking, I/O testing and eventually the product testing can be achieved.

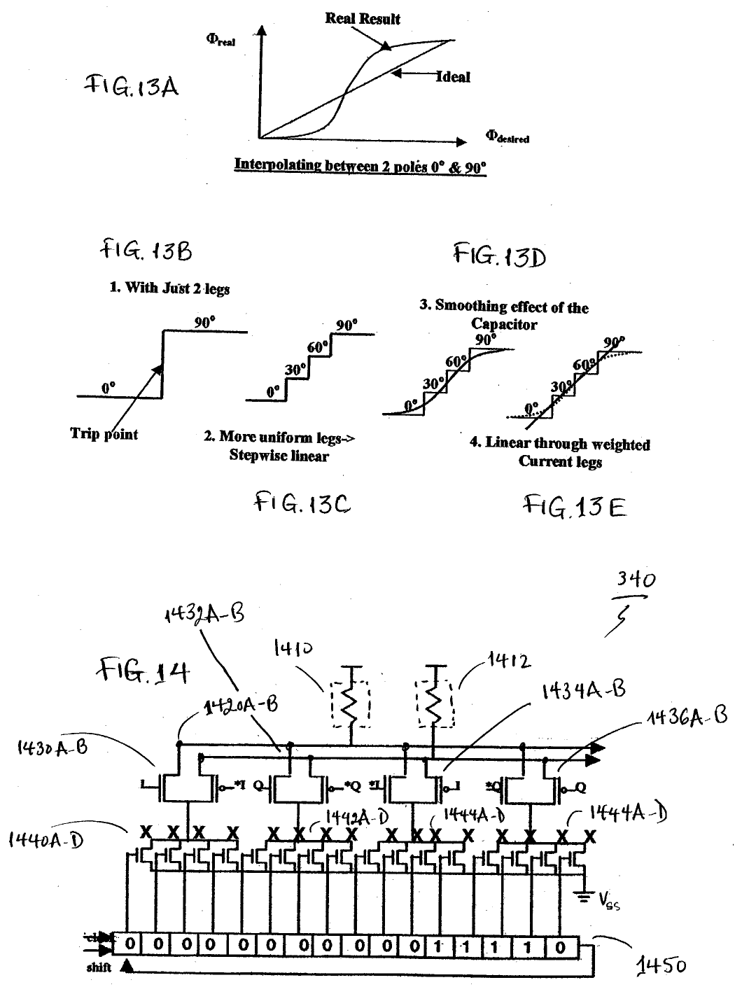

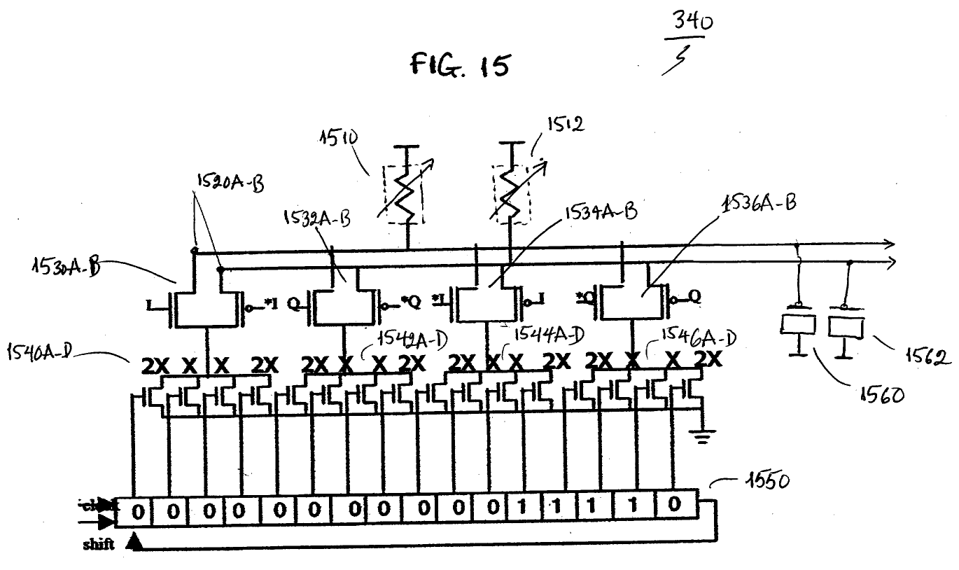

FIGS. 13A-13E illustrate example steps involved in reducing non-linearity in phase tracking interpolation according to an embodiment of the present invention. FIG. 13A illustrates an example graph of an ideal phase tracking interpolation operation versus an actual phase tracking interpolation operation of typical interpolator circuits when interpolating between two reference phases, i.e., 0° and 90° of a reference clock (i.e., multi-phase clock). Ideally, the interpolation transfer function is a straight line. However, the actual interpolation transfer function of most interpolator circuits is non-linear. This is because typical interpolator circuits do not mix phases linearly, and one reason why non-linearity occurs is because the dominance of one reference phase over another reference phase when interpolating closer to the reference phase. In this situation, non-linearity is due to sudden trip-point or the current switch (interpolation) from one reference phase, 0° phase, and another reference phase, 90° phase, as shown in FIG. 13B. If the number of current sources or the number of grains between a phase pair is doubled, as shown in FIG. 13C, the result will be a stair case type response. If capacitors are integrated at the summing node to distribute the current mixing effect, the resulting stair case type response may be smoothened. However, non-linearity may still exist in terms of movement of the trip points when one current source corresponding to a phase turns off and the other corresponding to the adjacent phase turns on. Therefore, according to an embodiment of the present invention, a weighted current leg method may be advantageously utilized to equalize, apportion and distribute current among phases of a reference clock (i.e., multi-phase clock) that are being interpolated while maintaining the total current drawn in order to reduce non-linearity in phase mixing. Having weighted current legs reduce sudden changes in the current tripping, and bring the resultant phases closer to what is desired as shown in FIG. 13E. The weight may be made adaptive depending on the circuit behavior in silicon to reduce sampling jitter and glitch noise into the timing budget of the IO link.

FIG. 14 illustrates an example implementation of an example phase tracking interpolator 340 using weighted current legs according to an embodiment of the present invention. The example phase tracking interpolator 340 shows the phase interpolation between a pair of evenly spaced phases of a reference clock (i.e., multi-phase clock) to produce a local sampling clock φₛ that is used to track the remote data clock (received clock) φ_{d} encoded in the data stream received from the I/O link 130. The same structure may be repeated a number of times to interpolate between any numbers of evenly spaced phases required.

As shown in FIG. 14, the phase tracking interpolator 340 may comprise two loads 1410-1412; four differential transistor pairs 1430A-1430B, 1432A-1432B, 1434A-1434B and 1436A-1436B connected to the loads 1410-1412, via respective integrating nodes 1420-1422 serving as output nodes (i.e., output terminal), with each pair of which differential transistor pairs coupled to receive a phase pair of a reference clock (i.e., evenly spaced in-phase “I” and its complement “\overline{I}” from 0°, 90°, 180° and 270°; evenly spaced quadrature phase “Q” and its complement “\overline{Q}” from 0°, 90°, 180° and 270°), via respective input nodes (i.e., differential voltage input terminals); and each differential transistor pair includes four current tail sources 1440A-1440D, 1442A-1442D, 1444A-1444D or 1446A-1446D. A total of 16 current tail sources 1440A-1440D, 1442A-1442D, 1444A-1444D and 1446A-1446D may be used to interpolate between a phase pair of a reference clock (i.e., multi-phase clock).

In addition, a barrel shifter 1450 may be utilized, as part of the receiver tracking mechanism 330, to control application of a bias voltage (Vₛ) to the current tail sources 1440A-1440D, 1442A-1442D, 1444A-1444D or 1446A-1446D in accordance with interpolator control signals from the interpolator control unit 338, as shown in FIGS. 9-10, and shift whichever way one of the phases would sink less current and the other phase would sink more by the same amount. Likewise, capacitance (not shown) may be added at output and/or input nodes to improve the linearity of the phase interpolation transfer function of the phase tracking interpolator 340. Specifically, integrating capacitors may be connected to integrating nodes 1420-1422 used to slow down the edge rates of the signal transitions, thereby eliminating the step-wise shape of the transfer function, as shown in FIG. 13D. As a result, the resulting output waveforms are smoother, making the phase interpolation transfer function more linear. The integrating capacitors can also be used to fine-tune the operation of the phase interpolator circuit when its performance is affected by factors such as supply voltage, temperature, process, sheet resistance, etc.

The loads 1410-1412 are resistors. Each of the differential transistor pairs 1430A-1430B, 1432A-1432B, 1434A-1434B and 1436A-1436B may be implemented using N-MOSFETs. The current tail sources 1440A-1440D, 1442A-1442D, 1444A-1444D and 1446A-1446D are current source transistors having control electrodes coupled to receive the bias voltage, sources and drains coupled between the bias voltage (Vₛ) and ground (Vₛₛ). The current source transistors may be implemented with P-MOSFETs to weight current to its tails (legs) and distribute the current among phases of a reference clock (i.e., multi-phase clock) that are being interpolated while maintaining the total current drawn. Since the identical current sources are throughout the tails, the current sinking to ground (Vₛₛ) may be constant irrespective of how many current sources per phase pair are turned on. Hence, when the barrel shifter 1450 controlling the interpolator current tails shifts whichever way one of the phases would sink less current and the other phase would sink more by the exact same amount. This would continue through the number of bit periods the interpolator sweeps. However, the phase crossing at the integrating nodes 1420-1422 may still behave in a non-linear fashion, especially near the phase transitions. This can be attributed to less than expected current sinking when sudden phase transition occurs.

FIG. 15 illustrates an example implementation of a phase tracking interpolator according to another embodiment of the present invention. According to this example implementation of the present invention, the phase tracking interpolator 340 is designed to advantageously allow edge tracking and eliminate potential non-linearity caused when sudden phase transition occurs, i.e., when one current source corresponding to a phase turns off and the other current source corresponding to the adjacent phase turns on. Specifically, the current source transistors are resized to weight current so that a larger current is forced towards a weaker phase while the constant current is maintained to eliminate non-linearity in the transfer function. For is example, 2:1 (2×) current weighting at the outer current source transistors of each phase pair may be used to ensure that the larger current is forced towards the weaker phase. However, the weight may also be programmable depending on the response of the uniformly weighed interpolator.

As shown in FIG. 15, the example phase tracking interpolator 340 comprises similar elements shown in FIG. 14, including, for example, two loads 1510-1512; four differential transistor pairs 1530A-1530B, 1532A-1532B, 1534A-1534B and 1536A-1536B connected to the loads 1510-1512, via respective integrating nodes 1520-1522 serving as output nodes (i.e., output terminal), with each pair of which differential transistor pairs coupled to receive a phase pair of a reference clock (i.e., evenly spaced in-phase “I” and its complement “\overline{I}” from 0°, 90°, 180° and 270°; evenly spaced quadrature phase “Q” and its complement “\overline{Q}” from 0°, 90°, 180° and 270°), via respective input nodes (i.e., differential voltage input terminals); and each differential transistor pair includes four current tail sources 1540A-1540D, 1542A-1542D, 1544A-1544D or 1546A-1546D. A total of 16 current tail sources 1540A-1540D, 1542A-1542D, 1544A-1544D or 1546A-1546D may be used to interpolate between a phase pair of a reference clock (i.e., multi-phase clock).

Likewise, a barrel shifter 1550 may be utilized, as part of the receiver tracking mechanism 330, to control application of a bias voltage (Vₛ) to the current tail sources 1540A-1540D, 1542A-1542D, 1544A-1544D or 1546A-1546D in accordance with interpolator control signals from the interpolator control unit 338, as shown in FIGS. 9-10, and shift whichever way one of the phases would sink less current and the other phase would sink more by the same amount. Integrating capacitors 1560-1562 may also be added at output nodes to improve the linearity of the phase interpolation transfer function of the phase tracking interpolator 340. Specifically, the integrating capacitors 1560-1562 may be CMOS capacitors that are controllable to add or subtract capacitance to slow down the edge rates of the signal transitions, thereby eliminating the step-wise shape of the phase interpolation transfer function and instead smoothening the phase interpolation transfer function.

The example phase tracking interpolator 340, as shown in FIG. 15, is intended to perform phase interpolation between a pair of evenly spaced phases of a reference clock (i.e., multi-phase clock) to produce a local sampling clock φₛ that is used to track the remote data clock (received clock) encoded in the data stream received from the I/O link 130. However, the same structure may be repeated a number of times to interpolate between any numbers of evenly spaced phases required.

In one embodiment, the loads 1510-1512 are resistors. Alternatively, the loads 1510-1512 may be implemented with active loads such as diode-connected N-MOSFETs or P-MOSFETs with grounded gates. Each of the differential transistor pairs 1530A-1530B, 1532A-1532B, 1534A-1534B and 1536A-1536B may be implemented using N-MOSFETs. These transistors may alternatively be implemented with BJTs, P-MOSFETs, MESFETs, or other transistor devices.

The current tail sources 1540A-1540D, 1542A-1542D, 1544A-1544D or 1546A-1546D are current source transistors having control electrodes coupled to receive the bias voltage, sources and drains coupled between the bias voltage (Vₛ) and ground (Vₛₛ). The current source transistors may be implemented with NMOSFETs, PMOSFETs, or MOSFET transmission gates to weight current to its tails (legs) and distribute the current among phases that are being interpolated while maintaining the total current drawn.

In contrast to the example phase tracking interpolator shown in FIG. 14, the implementation shown in FIG. 15 utilizes the 2× current weighting at the outer current sources for each phase pair to allow edge tracking and eliminate potential non-linearity caused when sudden phase transition occurs, i.e., when one current source corresponding to a phase turns off and the other current source corresponding to the adjacent phase turns on.

Table 1 below provides a comparison between the weighted and uniform current leg cases showing the distribution of current mixing for various phase interpolation positions between a phase pair. A weight of 2:1 (2×) has been chosen for this example. However, the weight may be left as programmable depending on the response of the uniformly weighted interpolator.

| | | Phase 1 | | | | Phase 2 | | | Cur_{—} | Cur_{—} |
|---|---|---|---|---|---|---|---|---|---|---|
| Interp Type | | (0 deg) | | | | (90 deg) | | | Ph1 | Ph2 |
| Weighted | 2 | | | 2 | 2 | | | 2 | 6 | 0 |
| 0 | | 1 | 1 | | | 1 | 1 | | | |
| Uniform | 1 | 1 | 1 | 1 | 1 | 1 | 1 | 1 | 4 | 0 |
| Weighted | 2 | | | 2 | 2 | | | 2 | 4 | 2 |
| 22.5 | | 1 | 1 | | | 1 | 1 | | | |
| Uniform | 1 | 1 | 1 | 1 | 1 | 1 | 1 | 1 | 3 | 1 |
| Weighted | 2 | | | 2 | 2 | | | 2 | 3 | 3 |
| 45 | | 1 | 1 | | | 1 | 1 | | | |
| Uniform | 1 | 1 | 1 | 1 | 1 | 1 | 1 | 1 | 2 | 2 |
| Weighted | 2 | | | 2 | 2 | | | 2 | 2 | 4 |
| 67.5 | | 1 | 1 | | | 1 | 1 | | | |
| Uniform | 1 | 1 | 1 | 1 | 1 | 1 | 1 | 1 | 1 | 3 |
| Weighted | 2 | | | 2 | 2 | | | 2 | 0 | 6 |
| 90 deg | | 1 | 1 | | | 1 | 1 | | | |
| Uniform | 1 | 1 | 1 | 1 | 1 | 1 | 1 | 1 | 0 | 4 |

As shown in TABLE 1, when interpolating a desired output of 22.5°, for example, using the uniformly weighted implementation as shown in FIG. 14, three (3) parts of current corresponding to phase 0° would sink in while only one (1) part of current corresponding to phase 90° sink. Therefore in all probability, the three (3) parts would dominate resulting in an output closer to 0° rather than 22.5°.

In contrast to the uniformly weighted implementation shown in FIG. 14, the weighted current sources shown in FIG. 15, four (4) parts of current corresponding to phase 0° would sink in while two (2) parts of current corresponding to phase 90° sink. This evens out the domination of phase 0° and results in a more realistic output closer to 22.5°. Hence the non-linearity is fixed through transistor weighting.

Likewise, when interpolating a desired output of 67.5° using the uniformly weighted implementation as shown in FIG. 14, only one (1) part of current corresponding to phase 0° would sink in while three (3) parts of current corresponding to phase 90° sink. Therefore in all probability, the three (3) parts would dominate resulting in an output closer to 45° rather than 67.5°.

In contrast to the uniformly weighted implementation shown in FIG. 14, the weighted current sources shown in FIG. 15, two (2) parts of current corresponding to phase 0° would sink in while four (4) parts of current corresponding to phase 90° sink. This evens out the domination of phase 450 and results in a more realistic output closer to 67.5°. Hence the non-linearity is fixed through transistor weighting.

Potential advantages in terms of power saving can also be possible if the total current flowing is scaled down according (4×/6×). Moreover with weighted current legs, the capacitance 1560-1562 needed can be smaller than that needed for the uniform legs, which again can help reduce power

$$P = ( \frac{1}{2} {CV}^{2} ) .$$

Further, with smaller capacitance the swings at the integrating nodes 1520-1522 can be larger possibly giving rise to higher bandwidth.

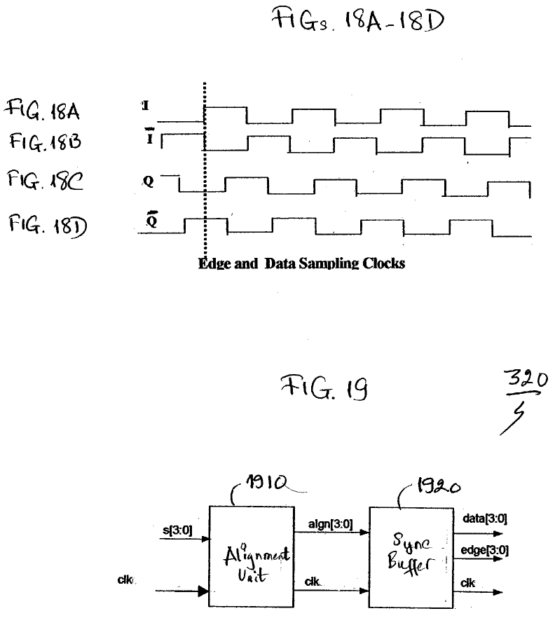

FIGS. 16-17 show the results comparing the interpolator linearity between two (2) phases with and without weighted current sources first with no capacitive loads and then with capacitive loads. Specifically, FIG. 16 illustrates an example comparison of interpolator linearity between weighted and uniform current sources with no capacitive loads. Similarly, FIG. 17 illustrates an example comparison of interpolator linearity between weighted and uniform current sources with capacitive loads.

As shown in FIG. 16, the transfer function 1610 of the phase tracking interpolator 340 using the weight current sources shown in FIG. 15 is represented in solid line, and the transfer function 1620 of the phase tracking interpolator 340 using the uniform current sources shown in FIG. 14 is represented in dotted line. Even when no capacitance is added at the integrated nodes, the transfer function 1610 using the weight current sources shown in FIG. 15 as represented in solid line is much more linear than the transfer function 1620 using the uniform current sources shown in FIG. 14.

If capacitance is added at the integrated nodes, the interpolator linearity can further be enhanced. As shown in FIG. 17, the transfer function 1710 of the phase tracking interpolator 340 using the weight current sources shown in FIG. 15 is represented in solid line, and the transfer function 1720 of the phase tracking interpolator 340 using the uniform current sources shown in FIG. 14 is represented in dotted line. The transfer function 1710 using the weight current sources shown in FIG. 15 as represented in solid line is slightly more linear than the transfer function 1720 using the uniform current sources shown in FIG. 14. However, in both instances, the interpolator linearity can be optimized.

In addition to the interpolator optimization, the synchronization and alignment unit (SAU) 320 and the receiver tracking mechanism 330, as shown in FIG. 3 and FIG. 9, may also be optimized to receive data and edge samples from the front amplifier 310, align and establish synchronization with single recovered clock edge before transfer the same to the vote generator 332 of the receiver tracking mechanism 330 where adjustments are made for the tracking function. Typically, edge samples are vulnerable to meta-stability as both the data and clock are simultaneously changing, and the edge samples are obtained by sampling right at the transition of the data samples. If data and edge samples received from the front amplifier 310, as shown in FIG. 3, are unstable, the receiver tracking mechanism 330 may be unable to successfully perform the tracking function using data and edge samples.

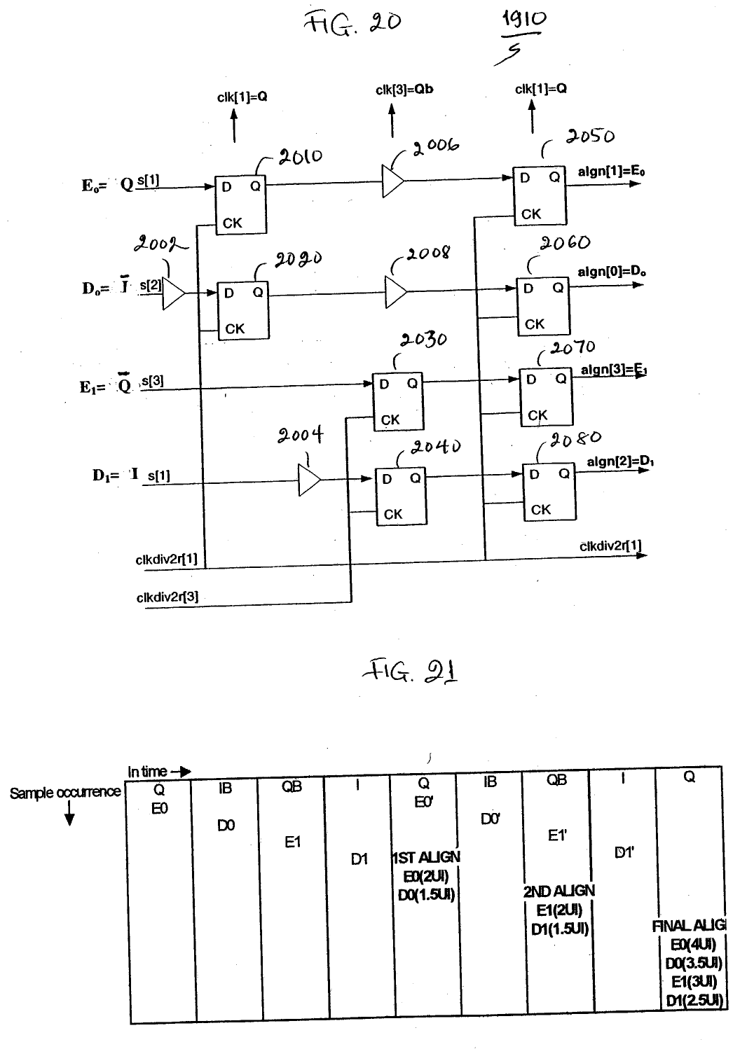

FIGS. 18A-18D illustrate example edge and data sampling clocks used to sample and process data input from the front amplifier 310 shown in FIG. 3. Specifically, FIGS. 18A-18B show a recovered in-phase clock “I” and its complement “\overline{I}” from an in-phase portion of the phase tracking interpolator 340, as shown in FIG. 3. Likewise, FIGS. 18C-18D show a recovered quadrature phase clock “Q” and its complement “\overline{Q}” from a quadrature portion of the phase tracking interpolator 340, as shown in FIG. 3. Quadrature phase clock “Q” is a 90° phase delay from the in-phase clock “I”. The “Q” and “\overline{Q}” samples, which are from the edges of data transitions, may be prone to meta-stability more than the relatively stable “I” and its complement “\overline{I}” samples as shown in FIGS. 18A-18D. Moreover the edge samples are collected at the rising edge of quadrature phase clocks “Q” and “\overline{Q}” shown in FIGS. 18C-18D. However, since the quadrature phase clocks “Q” and “\overline{Q}” transition after a 90° phase delay from the in-phase clocks “I” and “\overline{I}” transition respectively, the edge samples have approximately half bit cell (90° phase delay) less settling time compared to the data samples. As a result, it is essential that the critical paths through edge samples be provided for meta-stability.

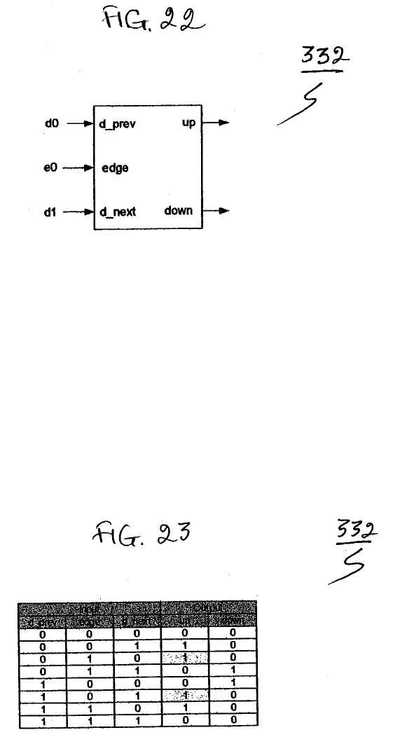

In order to obtain good tracking, the synchronization and alignment unit (SAU) 320 needs to receive meta-stable free inputs. A critical path having extra settling time for meta-stability prone edge samples may be provided at the front amplifier output, while simultaneously not increasing the data path latency. FIG. 19 illustrates an example synchronization and alignment unit (SAU) designed to improve meta-stability according to an embodiment of the present invention. As shown in FIG. 19, the synchronization and alignment unit (SAU) 320 may include an alignment unit 1910 arranged to align the edge and data samples and provide extra settling time to the more sensitive “Q” and “\overline{Q}” samples for meta-stability; and a synchronization buffer 1920 arranged to synchronize and buffer aligned samples to be forwarded to the vote generator 332 of the receiver tracking mechanism 330 to extract the phase error seen between the edge and data sampling clocks shown in FIGS. 18A-18D and the data transitions for dynamic phase tracking and adjustment.

FIG. 20 illustrates an example alignment unit 1910 of the synchronization and alignment unit (SAU) according to an embodiment of the present invention. The alignment unit 1910 utilizes a series of meta-stable flip-flops 2010, 2020, 2030, 2040, 2050, 2060, 2070, and 2080 and inverters 2002, 2004, 2006, and 2008 to delay and attain extra settling time for the sensitive “Q” and “\overline{Q}” samples.

As shown in FIG. 20, the alignment unit 1910 may comprise a first delay (D) flip-flop 2010 arranged to receive edge samples “E₀” by the quadrature phase clock “Q”, shown in FIG. 18C, and to produce a logic output indicating delayed edge samples; a second D flip-flop 2020 arranged to receive data samples “D₀” by the complement in-phase clock “\overline{I}”, as shown in FIG. 18B, via a buffer 2002, and to produce a logic output indicating delayed data samples; a third D flip-flop 2030 arranged to receive edge samples “E₁” by the complement quadrature phase clock “\overline{Q}”, shown in FIG. 18D, and to produce a logic output indicating delayed edge samples; a fourth D flip-flop 2040 arranged to receive data samples “D₁” by the complementary in-phase clock “I”, as shown in FIG. 18A, via a buffer 2004, and to produce a logic output indicating delayed data samples; a fifth D flip-flop 2050 arranged to receive delayed edge samples from the first D flip-flop 2010, via a buffer 2006, and to produce aligned edge samples; a sixth D flip-flop 2060 arranged to receive delayed data samples from the second D flip-flop 2020, via a buffer 2008, and to produce aligned data samples; a seventh D flip-flop 2070 arranged to receive edge samples from the third D flip-flop 2030, and to produce aligned edge samples; an eighth D flip-flop 2080 arranged to receive delayed data samples from the fourth D flip-flop 2040, and to produce aligned data samples. Each D flip-flop 2010, 2020, 2030, 2040, 2050, 2060, 2070 or 2080 has a single data input (D) and a single data output (Q) delayed by a single clock pulse. Each buffer 2002, 2004, 2006, or 2008 may be formed by two inverters arranged in series to pass the same signal polarity with a time delay and some amount of signal strengthening.

In the flip-flop arrangement shown in FIG. 20, edge samples E0 (by clock “Q”) occurs first in time followed by the data samples “D0” by the in-phase clock “\overline{I}”, edge samples “E1” by the complement quadrature phase clock “\overline{Q}”, and data samples “D1” by the in-phase clock “I”. As a result, the alignment method can buy an extra setting time for the edges compared to less critical data samples. For example, the extra setting time can be 0.5 unit interval (¼ clock period) for the edge samples when compared to the data samples, if the data samples D0 (by clock “I”) is arranged to occur first in time followed by E0 (by clock “Q”), D1 (by clock “\overline{I}”) and E1 (by clock “\overline{Q}”).

FIG. 21 illustrates an example timing diagram of obtaining extra settling time by pipelining edge samples before data samples in the synchronization and alignment unit (SAU) 320. The timing diagram is shown in terms of time and sample occurrence. When an edge sample E0 driven by the quadrature clock “Q” occurs at a first followed by a data sample “D0” driven by the complement in-phase clock “\overline{I}”, an edge sample “E1” by the complement quadrature phase clock “Q” and a data sample “D1” by the in-phase clock “I” within a clock period, an extra setting time can be obtained for the edge samples for alignment since the 1^{st} alignment of edge samples occurs at a next edge sample E0′. At the 1^{st} alignment, the edge sample E0 will have two (2) unit intervals (UI) wherein each UI is ½ clock period, and the data sample D0 will have 1⅕ unit intervals (UI). The 2^{nd} alignment occurs at the next occurrence of a next edge sample E1′. At the 2^{nd} alignment, the edge sample E1 will have two (2) unit intervals (UI) wherein each UI is ½ clock period, and the data sample D1 will have 1⅕ unit intervals (UI). The final alignment occurs at the next occurrence of another edge sample′. At the final alignment, the edge sample E0 will have four (4) unit intervals (UI), the data sample D0 will have 3⅕ unit intervals (UI), the edge sample E1 will have three (3) unit intervals (UI), and the data sample D1 will have 2⅕ unit intervals (UI).

In the alignment method as described with reference to FIG. 20 and FIG. 21, the mean time between failures (MTBF) may be extended to cover product life cycle, for example, product life cycle greater than 100 years.

The formula used to calculate mean-time-between-failures (MTFB) may be as follows:

$$MTBF = \frac{1}{{t}_{a} {f}_{B} {f}_{A} {ⅇ}^{( - \frac{{t}_{w}}{τ} )}}$$

where, tₐ=Aperture time=tₛₑₜᵤₚ+t_{hold}

f_{A}=Event frequency on data lines

f_{B}=Clock frequency that uniformly distributes the edges within a data window

t_{w}=Settling time allowed for the meta-stable signal to settle.

This term may be defined for a specific flip-flop design as the total UI's available for settling minus delays through the slave of each flip-flop minus any setup time required for subsequent flip-flop.

τ=The regenerative time constant of the flip flop

Below is an example calculation using the MTBF formula based on expected typical values for a custom built flip-flop.

The numbers are at a data rate of 5 Gb/s (worst case) or a UI=200 ps.

tₐ=80 ps (setup=40 ps+hold=40 ps)

f_{A}=5×109

f_{B}=2.5×109

t_{w}=3*UI−2*(clk_to_Q delay of flops)−1*(setup time of subsequent flops)

=600 ps−2*(60 ps)−(40 ps)

=440 ps

τ=10 ps (for a custom flop @ realistic slow skew corner)

Therefore:

$$MTBF = \frac{1}{{t}_{a} {f}_{B} {f}_{A} {ⅇ}^{( - \frac{{t}_{w}}{τ} )}} = 7.533 \times {10}^{11} secs = 13040 years ( > 100 year target ) .$$

Since edge samples are virtually available and not critical in data receiving, these edge samples can be readily re-ordered to arrive before data samples in order to attain extra settling time for the edges. Additional benefits in terms of latency can also be obtained.

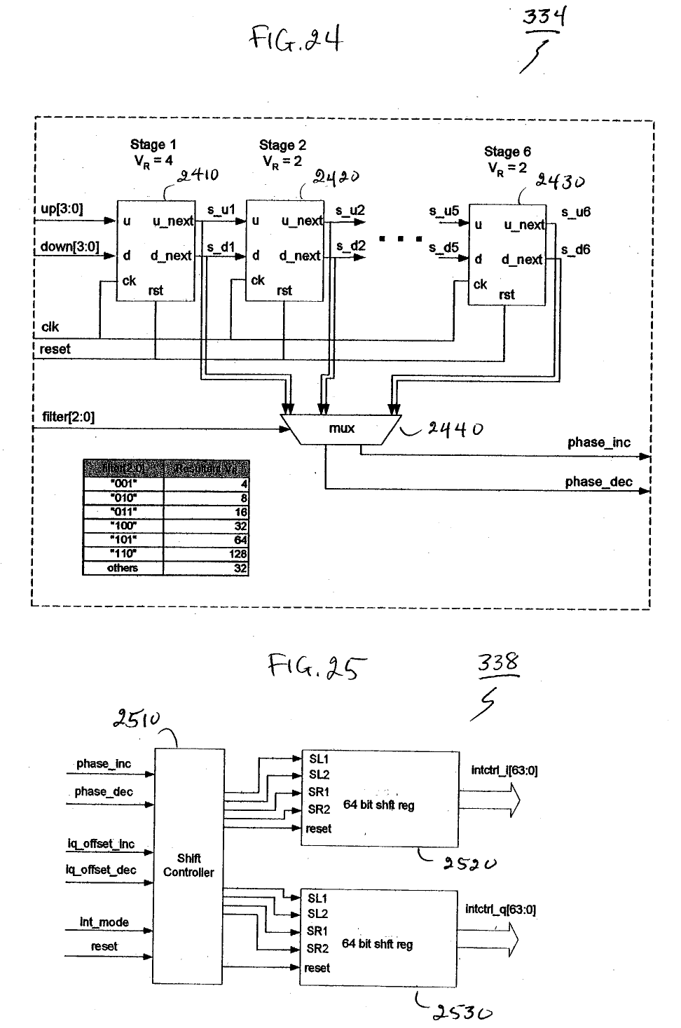

Turning now to FIG. 22, an example vote generator 332 in the example receiver tracking mechanism 330 according to an embodiment of the present invention is illustrated. The vote generator 332 is used to decide, based on the accumulation and analysis of consecutive samples of a data signal (i.e., data samples and edge samples), whether to move up/down the local sampling clock φₛ, i.e., delay/advance the phases of the local sampling clock φₛ until a lock condition is established. As shown in FIG. 22, the vote generator 332 may be implemented as a programmable logic array (PLA) arranged to receive an edge sample at an edge terminal, previous and next data samples at data terminals, and to generate an up/down vote in response to the accumulation and analysis of both data and edge samples, i.e., sample value relative to the local sampling clock φₛ.

Alternatively, the vote generator 332 may also be implemented as a look-up table, as shown in FIG. 23, to receive edge and consecutive data samples and generate an up/down vote. An up vote from the vote generator 332 may be used to delay the phases of the local sampling clock φₛ until a lock condition is established. Likewise, a down vote from the vote generator 332 may be used to advance the phases of the local sampling clock φₛ until a lock condition is established.

As shown in FIG. 23, for example, if a previous data sample indicates “0”, an edge sample indicates “1” and a next data sample indicates “1”, then the up vote will be “0” and the down vote will be “1”. Likewise, if a previous data sample indicates “1”, an edge sample indicates “0” and a next data sample indicates “0”, then the up vote will be “0” and the down vote will be “1”. However, if a previous data sample indicates “1”, an edge sample indicates “1” and a next data sample indicates “0”, then the up vote will be “1” and the down vote will be “0”. An up/down vote from the vote generator 332 may then be used to delay/advance the phases of a local sampling clock φₛ until a lock condition is established.

Based on the up/down vote from the vote generator 332, the loop filter 334, as shown in FIG. 9, is used to determine if the difference between the up/down vote is equal or greater than a desired threshold V_{R}. One example embodiment of such a loop filter 334 is shown in FIG. 24, including multiple loop filter stages to get the desired threshold V_{R}. As shown in FIG. 24, the example loop filter 334 may comprise six loop filter stages 2410, 2420, 2430, 2440, 2450, and 2560 arranged in a cascade to determine if the difference between the up/down vote is equal greater than a desired threshold V_{R}; and a multiplexor 2470 arranged to select outputs from the cascading loop filter stages 2410, 2420, 2430, 2440, 2450, and 2560 based on a filter selection signal.

Each loop filter stage 2410, 2420, 2430, 2440, 2450, or 2560 may be implemented as a programmable logic array (PLA) to produce programmed outputs based on the input up/down vote from either the vote generator 332 or a preceding loop filter stage. Each loop filter stage may produce programmed outputs based on the following conditions:

(1) if (u−d)≧a desired threshold (for example, “2”), then u_next≦“1” and reset; and

(2) if (d−u))≧2, then u_next≦“1” and reset.

In other words, if the difference between an up vote and a down vote is equal or greater than “2”, then an output up vote will be equal or lesser than “1” and the loop filter will be reset. Likewise, if the difference between a down vote and an up vote is equal or greater than “2”, then an output up vote will be equal or lesser than “1” and the loop filter will be reset.

FIG. 25 illustrates an example interpolator control unit 338 in the example receiver tracking mechanism 330 according to an embodiment of the present invention. The interpolator control unit 338 generates interpolator control signals that are used by the phase tracking interpolator 340, as shown in FIGS. 9-10 and FIGS. 14-15, to interpolate the phases of a reference clock (i.e., multi-phase clock) and generate accordingly a local sampling clock φₛ. The phase relationship between in-phase and quadrature phases can be programmed for test purposes.

As shown in FIG. 25, the interpolator control unit 338 may comprise a shift controller 2510 and a pair of 64-bit shift registers 2520 and 2530. The shift controller 2510 is used to provide bit-codes required for the “mixing of current and hence phases” based on inputs from the loop filter 334 on whether to move up or down. Specifically, the shift controller 2510 shifts (left or right) 16 “ones” by one bit position within the 64 bit barrel for temporary storage in the 64-bit shift registers 2520 and 2530. The appearance of 16 consecutive “ones” anywhere between the possible 64 barrel positions determines in what ratio should the current be mixed between the reference phases. Here the numbers “16” and “64” may be chosen for a particular example of implementation. However, the chosen numbers may not be limited thereto, depending upon various implementation examples. The 64-bit shift registers 2520 and 2530 produce outputs, i.e., the interpolator control signals to the phase tracking interpolator 340, as shown in FIGS. 9-10 and FIGS. 14-15, in order to interpolate the phases of a reference clock (i.e., multi-phase clock) and generate a local sampling clock φₛ as described with reference to FIGS. 9-10 and FIGS. 14-15.

As described from the foregoing, the present invention advantageously provides a tracking-based receiver system utilizing a mechanism to track data with faster locking time, more robust phase tracking and finer interpolator resolution that aids applications such as input/output (I/O) testing with greater timing margins. The receiver tracking mechanism for robust in-phase and quadrature phase tracking is designed to improve mean time between failures in sampling receiver based systems and low latency data path. A phase tracking interpolator is designed to improve the quality of IO testing and allow room for optimization, including edge tracking as well as data latching at a specified angle other than the traditional 90 degrees. The interpolator construction and circuits advantageously enable high resolution and linearity.

The present invention can be embodied in the form of methods and apparatuses for practicing those methods. The present invention can also be embodied in the form of program code embodied in tangible media, such as floppy diskettes, CD-ROMs, hard drives, or any other machine-readable storage medium, wherein, when the program code is loaded into and executed by a machine, such as a computer system, the machine becomes an apparatus for practicing the invention. The present invention can also be embodied in the form of program code, for example, whether stored in a storage medium, loaded into and/or executed by a machine, or transmitted over some transmission medium, such as over electrical wiring or cabling, through fiber optics, or via electromagnetic radiation, wherein, when the program code is loaded into and executed by a machine, such as a computer system, the machine becomes an apparatus for practicing the invention. When implemented on a general-purpose processor, the program code segments combine with the processor to provide a unique device that operates analogously to specific logic circuits.

While there have been illustrated and described what are considered to be example embodiments of the present invention, it will be understood by those skilled in the art and as technology develops that various changes and modifications may be made, and equivalents may be substituted for elements thereof without departing from the true scope of the present invention. Many modifications may be made to adapt the teachings of the present invention to a particular situation without departing from the scope thereof. For example, the receiver circuit shown in FIG. 3 may be configured differently without using a synchronization alignment unit (SAU). The receiver tracking mechanism, as shown in FIG. 9, may also be a state machine configured to execute all functions described. Alternatively, the drift direction predictor, as shown in FIG. 9, may be a state machine configured to execute the direction prediction function and the drift prediction function. Other circuit elements of the direction predictor and the drift predictor, as shown in FIG. 10, the phase tracking interpolator, as shown in FIGS. 14-15, the synchronization and alignment unit (SAU), as shown in FIG. 20, the vote generator, as shown in FIGS. 22-23, the loop filter, as shown in FIG. 24 and the interpolator control unit, as shown in FIG. 25, can be implemented with different types of logic elements, including, for example, AND, NAND, OR and XOR gates. In addition, there are other techniques that can be used to reduce the lock time in the phase tracking interpolator. For example, when the phase tracking interpolator, as shown in FIG. 9, is forced to lock to a later edge, the resulting drift velocity and the interpolator velocity may be additive, therefore making the lock time small.

$${DesiredLockTime}_{Interpolator} \geq \frac{{180}^{°}}{InterpolatorVelocity + LinkDriftVelocity}$$

In this situation, if the link drift velocity is set to “0”, the result may be a bounded lock time and a finer granularity. Another method to improve the interpolator velocity during start up is to decrease the interpolator filtering count. For example, if the loop filter requires 32 votes to advance a leg, reducing the votes to 16 may cause the previous 32 votes to advance two legs, thereby increasing the lock velocity. After initial locking time, the weight can be back to the operational larger value, thereby getting the optimum filtering for the operational link. The interpolator velocity can also be increased during startup by keeping the vote requirements constant, but increasing the granularity. For example, during initial lock the votes increment legs by two (or several times nominal) thereby increasing the locking velocity. After the initial lock, the granularity may be reset to nominal value. In addition, the interpolator may be periodically updated and calibrated to support finer interpolation that leads to more precise sampling clock placements, thereby improving IO testing ability (read yields) and link performance. In view of the alternative possibilities, it is intended, therefore, that the present invention not be limited to the various example embodiments disclosed, but that the present invention includes all embodiments falling within the scope of the appended claims.

What is claimed is:

1. A receiver circuit, comprising:
a front amplifier to receive data from an I/O link driven by a remote clock signal;
an interpolator to generate a local clock signal to track the remote clock signal encoded in the data; and
a tracking mechanism to extract phase information about the remote clock signal from the data and to dynamically adjust the phase of the local clock signal that tracks the remote clock signal in accordance with extracted phase information for subsequent data processing functions,
wherein the tracking mechanism is configured to predict a direction of a phase drift, and force the interpolator to move against the phase drift so as to reduce lock time.

2. The receiver circuit as claimed in claim 1, wherein the phase drift is measured between incoming data phase and the remote clock signal.

3. The receiver circuit as claimed in claim 1, wherein the tracking mechanism comprises:
a vote generator to vote whether to move up/down the local clock signal based on the accumulation and analysis of both data and edge samples;
a loop filter to provide appropriate filter amplification of the up/down votes from the vote generator;
a drift direction predictor to predict the direction of the phase drift; and
an interpolator control unit to control operation of the interpolator, including drift compensation, based on up/down controls from the loop filter.

4. The receiver circuit as claimed in claim 3, wherein the drift direction predictor includes a direction predictor logic arranged to predict the direction of the phase drift, and a drift predictor logic arranged to predict the drift compensation necessary to ensure the interpolation movement “against the drift”.

5. The receiver circuit as claimed in claim 3, wherein the interpolator control unit is configured to delay/advance phases of the local clock signal until a lock condition is established, in accordance with the up/down votes from the vote generator.

6. The receiver circuit as claimed in claim 1, wherein the tracking mechanism comprises:
a phase comparison circuit to compare phases of the remote clock signal and the local clock signal;
a loop filter to provide appropriate filter amplification to up/down controls from the phase comparison circuit;
a drift direction predictor to predict the direction of the phase drift; and
an interpolator control unit to control the operation of the interpolator, including drift compensation, based on the up/down controls from the loop filter.

7. The receiver circuit as claimed in claim 6, wherein the drift direction predictor includes a direction predictor logic arranged to predict the direction of the phase drift, and a drift predictor logic arranged to predict the drift compensation necessary to ensure the interpolation movement “against the drift”.

8. The receiver circuit as claimed in claim 7, wherein the direction predictor logic comprises:
D flip-flops arranged to receive the up/down controls from the loop filter and produce logic outputs that indicate the drift direction; and
an OR gate arranged to logically combine the outputs from the D flip-flops and provide a feedback to control the D flip-flops.

9. The receiver circuit as claimed in claim 7, wherein the drift predictor logic comprises:
counters arranged to count the remote clock signal and the local clock signal; and
a comparator arranged to compare clock counts from the counters, determine the drift direction based on a difference in clock counts and provide the drift compensation to ensure that the interpolator movement is “against the drift”.

10. The receiver circuit as claimed in claim 1, wherein the interpolator comprises:
a plurality of differential transistor pairs, each pair of differential transistors having sources and drains commonly coupled, and gate electrodes coupled to receive a phase pair of a reference clock signal, via input terminals; and
a plurality of tail current sources coupled to the commonly coupled sources of each pair of differential transistors, to interpolate between the phase pair of the reference clock signal; and
one or more active loads commonly coupled to the drains of the differential transistor pairs, via an output terminal;
wherein the tail current sources coupled to the commonly coupled sources of each pair of differential transistors utilize 2:1 current weighting at outer tail current sources relative to inner tail current sources to apportion and distribute the current among phases of the reference clock signal that are being interpolated while maintaining the total current drawn to improve linearity of the interpolator.

11. The receiver circuit as claimed in claim 10, wherein the interpolator further comprises CMOS capacitors coupled to the output terminal to provide a controllable amount of capacitance at the output terminal to improve the linearity of the interpolator.

12. The receiver circuit as claimed in claim 10, wherein the current tail sources are current source transistors implemented to weight current to its tails and distribute the current among the phases of the reference clock signal that are being interpolated while maintaining the total current drawn.

13. The receiver circuit as claimed in claim 10, wherein each of the differential transistor pairs comprises one selected from a group consisting of N-type metal oxide semiconductor field effect transistors (MOSFETs), P-type MOSFETs, and bipolar junction transistors (BJTs).

14. The receiver circuit as claimed in claim 10, wherein at least one of the one or more active loads comprises one selected from a group consisting of resistors, diode-connected N-type MOSFETs, and P-type MOSFETs.

15. The receiver circuit as claimed in claim 1, further comprising:
a synchronization and alignment unit (SAU) arranged between the front amplifier and the tracking mechanism, to align and synchronize data and edge samples and provide extra settling time to sensitive edge samples for meta-stability.

16. The receiver circuit as claimed in claim 15, wherein the synchronization and alignment unit (SAU) comprises:
an alignment unit arranged to align the edge and data samples and provide extra settling time to the sensitive edge samples for meta-stability; and
a synchronization buffer arranged to synchronize and buffer aligned samples to be forwarded to the tracking mechanism to extract the phase error obtained between the local sampling clock and data transitions for dynamic phase tracking and adjustment.

17. The receiver circuit as claimed in claim 16, wherein the alignment unit comprises:
a first D flip-flop arranged to receive edge samples by a first phase of the reference clock signal and to produce a logic output indicating delayed edge samples;
a second D flip-flop arranged to receive data samples by a second phase of the reference clock signal, via a first buffer, and to produce a logic output indicating delayed data samples;
a third D flip-flop arranged to receive edge samples by a third phase of the reference clock signal and to produce a logic output indicating delayed edge samples;
a fourth D flip-flop arranged to receive data samples by a fourth phase of the reference clock signal, via a second buffer, and to produce a logic output indicating delayed data samples;
a fifth D flip-flop arranged to receive delayed edge samples from the first D flip-flop, via a third buffer, and to produce aligned edge samples;
a sixth D flip-flop arranged to receive delayed data samples from the second D flip-flop, via a fourth buffer, and to produce aligned data samples;
a seventh D flip-flop arranged to receive edge samples from the third D flip-flop and to produce aligned edge samples; and
an eighth D flip-flop arranged to receive delayed data samples from the fourth D flip-flop and to produce aligned data samples.

18. The receiver circuit as claimed in claim 3, wherein the vote generator is implemented as a programmable logic array (PLA) or a look-up table arranged to receive edge and data samples and generate, in accordance with the accumulation and analysis of both edge and data samples relative to the local clock signal, the up/down vote used to advance/delay the phases of the local clock signal until a lock condition is established.

19. The receiver circuit as claimed in claim 3, wherein the loop filter comprises:
a plurality of loop filter stages arranged in a cascade to determine if the difference between the up/down vote is equal greater than a desired threshold; and
a multiplexor arranged to select outputs from the cascading loop filter stages based on a filter selection signal.

20. A phase tracking interpolator, comprising:
a plurality of differential transistor pairs, each pair of differential transistors having sources and drains commonly coupled, and gate electrodes coupled to receive a phase pair of a reference clock signal, via input terminals; and
a plurality of tail current sources coupled to the commonly coupled sources of each pair of differential transistors, to interpolate between the phase pair of the reference clock signal; and
one or more active loads commonly coupled to the drains of the differential transistor pairs, via an output terminal;
wherein the tail current sources coupled to the commonly coupled sources of each pair of differential transistors utilize 2:1 current weighting at outer tail current sources relative to inner tail current sources to apportion and distribute the current among phases of the reference clock signal that are being interpolated while maintaining the total current drawn to improve linearity of the interpolator.

21. The phase tracking interpolator as claimed in claim 20, further comprising CMOS capacitors coupled to the output terminal to provide a controllable amount of capacitance at the output terminal to improve the linearity of the interpolator.

22. The phase tracking interpolator as claimed in claim 20, wherein the current tail sources are current source transistors implemented to weight current to its tails and distribute the current among the phases of the reference clock signal that are being interpolated while maintaining the total current drawn.

23. The phase tracking interpolator as claimed in claim 20, wherein each of the differential transistor pairs comprises one selected from a group consisting of N-type metal oxide semiconductor field effect transistors (MOSFETs), P-type MOSFETs, and bipolar junction transistors (BJTs).

24. The phase tracking interpolator as claimed in claim 20, wherein at least one of the one or more active loads comprises one selected from a group consisting of resistors, diode-connected N-type MOSFETs, and P-type MOSFETs.

25. A phase tracking interpolator comprising;
at least one pair of differential transistors having sources and drains commonly coupled, and gate electrodes coupled to receive a phase pair of a reference clock signal; and
tail current sources coupled to the commonly coupled sources of the differential transistor pair, to interpolate between the phase pair of the reference clock signal; and
at least one active load coupled to the commonly coupled drains of the differential transistor pair;
wherein the tail current sources coupled to the commonly coupled sources of each pair of differential transistors utilize a predetermined current weighting ratio at outer tail current sources relative to inner tail current sources to apportion and distribute the current among phases of the reference clock signal that are being interpolated while maintaining the total current drawn to improve linearity of the interpolator.

26. The phase tracking interpolator as claimed in claim 25, further comprising CMOS capacitors coupled to the commonly coupled drains of the differential transistor pair to provide a controllable amount of capacitance at an output terminal to improve the linearity of the interpolator.

27. The phase tracking interpolator as claimed in claim 25, wherein the current tail sources are current source transistors implemented to weight current to its tails and distribute the current among the phases of the reference clock signal that are being interpolated while maintaining the total current drawn.

28. The phase tracking interpolator as claimed in claim 25, wherein the differential transistor pair comprises one selected from a group consisting of N-type metal oxide semiconductor field effect transistors (MOSFETs), P-type MOSFETs, and bipolar junction transistors (BJTs).

29. The phase tracking interpolator as claimed in claim 25, wherein the active load comprises one selected from a group consisting of resistors, diode-connected N-type MOSFETs, and P-type MOSFETs.

30. A receiver circuit comprising:
a front amplifier to receive data from an I/O link driven by a remote clock signal;
an interpolator to generate a local clock signal to track the remote clock signal encoded in the data;
an alignment unit to align data and edge samples and provide extra settling time to sensitive edge samples for meta-stability; and
a tracking mechanism to extract phase information about the remote clock signal from aligned data and edge samples, and to dynamically adjust the phase of the local clock signal that tracks the remote clock signal in accordance with extracted phase information for subsequent data processing functions.

31. The receiver circuit as claimed in claim 30, wherein the alignment unit comprises:
a first D flip-flop arranged to receive edge samples by a first phase of the reference clock signal and to produce a logic output indicating delayed edge samples;
a second D flip-flop arranged to receive data samples by a second phase of the reference clock signal, via a first buffer, and to produce a logic output indicating delayed data samples;
a third D flip-flop arranged to receive edge samples by a third phase of the reference clock signal and to produce a logic output indicating delayed edge samples;
a fourth D flip-flop arranged to receive data samples by a fourth phase of the reference clock signal, via a second buffer, and to produce a logic output indicating delayed data samples;
a fifth D flip-flop arranged to receive delayed edge samples from the first D flip-flop, via a third buffer, and to produce aligned edge samples;
a sixth D flip-flop arranged to receive delayed data samples from the second D flip-flop, via a fourth buffer, and to produce aligned data samples;
a seventh D flip-flop arranged to receive edge samples from the third D flip-flop and to produce aligned edge samples; and
an eighth D flip-flop arranged to receive delayed data samples from the fourth D flip-flop and to produce aligned data samples.

32. The receiver circuit as claimed in claim 30, wherein the tracking mechanism is configured to predict a direction of a phase drift, and force the interpolator to move against the phase drift so as to reduce lock time, the phase drift being measured between incoming data phase and the remote clock signal.

33. The receiver circuit as claimed in claim 30, wherein the tracking mechanism comprises:
a vote generator to vote whether to move up/down the local clock signal based on the accumulation and analysis of both data and edge samples;
a loop filter to provide appropriate filter amplification of the up/down votes from the vote generator;
a drift direction predictor to predict the direction of the phase drift; and
an interpolator control unit to control operation of the interpolator, including drift compensation, based on up/down controls from the loop filter.

34. The receiver circuit as claimed in claim 33, wherein the drift direction predictor includes a direction predictor logic arranged to predict the direction of the phase drift, and a drift predictor logic arranged to predict the drift compensation necessary to ensure the interpolation movement “against the drift”.

35. The receiver circuit as claimed in claim 34, wherein the direction predictor logic comprises:
D flip-flops arranged to receive the up/down controls from the loop filter and produce logic outputs that indicate the drift direction; and
an OR gate arranged to logically combine the outputs from the D flip-flops and provide a feedback to control the D flip-flops.

36. The receiver circuit as claimed in claim 34, wherein the drift predictor logic comprises:
counters arranged to count the remote clock signal and the local clock signal; and
a comparator arranged to compare clock counts from the counters, determine the drift direction based on a difference in clock counts and provide the drift compensation to ensure that the interpolator movement is “against the drift”.

37. The receiver circuit as claimed in claim 30, wherein the interpolator comprises:
at least one pair of differential transistors having sources and drains commonly coupled, and gate electrodes coupled to receive a phase pair of a reference clock signal; and
tail current sources coupled to the commonly coupled sources of the differential transistor pair, to interpolate between the phase pair of the reference clock signal; and
at least one active load coupled to the commonly coupled drains of the differential transistor pair;
wherein the tail current sources coupled to the commonly coupled sources of each pair of differential transistors utilize a predetermined current weighting ratio at outer tail current sources relative to inner tail current sources to apportion and distribute the current among phases of the reference clock signal that are being interpolated while maintaining the total current drawn to improve linearity of the interpolator.

38. The receiver circuit as claimed in claim 37, further comprising CMOS capacitors coupled to the commonly coupled drains of the differential transistor pair to provide a controllable amount of capacitance at an output terminal to improve the linearity of the interpolator.

39. The receiver circuit as claimed in claim 37, wherein the current tail sources are current source transistors implemented to weight current to its tails and distribute the current among the phases of the reference clock signal that are being interpolated while maintaining the total current drawn.

40. The receiver circuit as claimed in claim 33, wherein the vote generator is implemented as a programmable logic array (PLA) or a look-up table arranged to receive the edge and data samples and generate, in accordance with the accumulation and analysis of both edge and data samples relative to the local clock signal, the up/down vote used to advance/delay the phases of the local clock signal until a lock condition is established.
